(19) United States
(12) Patent Application Publication
(10) Pub. No.: US 2023/0249741 A1
(43) Pub. Date: Aug. 10, 2023

(54) POWER-ASSISTED STEERING FOR A MOTOR VEHICLE

(71) Applicants: thyssenkrupp Presta AG, Eschen (LI); thyssenkrupp AG, Essen (DE)

(72) Inventors: András ILLÉS, Gams (CH); Dennis SEIFRIED, Oberriet (CH)

(73) Assignees: thyssenkrupp Presta AG, Eschen (LI); thyssenkrupp AG, Essen (DE)

(21) Appl. No.: 18/014,600

(22) PCT Filed: Jul. 5, 2021
(86) PCT No.: PCT/EP2021/068492

§ 371 Date: Jan. 5, 2023

(30) Foreign Application Priority Data
Jul. 8, 2020 (DE) 10 2020 208 584.6

(51) Int. Cl. B62D 5/04

(52) U.S. Cl. CPC B62D 5/0448

(57) ABSTRACT

A power assisted steering system may include a threaded spindle that engages in a spindle nut, extends in a direction of a spindle axis, and is axially displaceable in a housing; and a drive unit having a gearwheel that is connected to the spindle nut in a rotationally fixed manner, can be driven rotatably about the spindle axis, and is rotatably mounted in the housing in a bearing arrangement. The bearing arrangement may have at least one bearing outer ring that is axially supported on the housing at an end face via a spring element, that is received coaxially in a sleeve element, and that is held radially in the housing. The spring element may be formed as a spring portion, and the sleeve element may be formed as a sleeve portion that is connected in one piece to the spring portion, on a one-piece carrier sleeve.

### Prior Art

The invention relates to a power assisted steering system for a motor vehicle, comprising a threaded spindle, which engages in a spindle nut, extends in the direction of a spindle axis and is axially displaceable in a housing, and a drive unit having a gearwheel, which is connected to the spindle nut in a rotationally fixed manner, can be driven for rotation about the spindle axis and is rotatably mounted in the housing in a bearing arrangement which has at least one bearing outer ring, which is axially supported on the housing at the end face via a spring element and which is received coaxially in a sleeve element and held radially in the housing.

In a power assisted steering system, in addition to a steering command which is manually input into the steering shaft via the steering wheel, auxiliary power is generated by an electromotive auxiliary power drive and coupled into the steering train to support the steering movement of the steered wheels.

In a rack and pinion steering system, a steering pinion is mounted on the steering shaft, which steering pinion is in engagement with a toothed rack in a steering gear, which toothed rack is linearly displaceably mounted in a housing and is connected to the track rods of the steered wheels so that a manual rotation of the steering shaft brings about a displacement of the toothed rack and thus generates a steering angle.

To couple auxiliary power into a rack and pinion steering system, it is known from DE 10 2013 006 432 A1, for example, to provide a motor-driven spindle drive with which linear auxiliary power may be applied to the toothed rack. The threaded spindle of the spindle drive, whereof the spindle axis extends axially in the displacement direction, is connected to the toothed rack in a fixed manner and engages in a spindle nut which is rotatably mounted in an axially supported manner in the housing. Via a gearwheel, which is connected coaxially to the spindle nut, for example in the form of a toothing revolving externally on the spindle nut, the spindle nut may be driven in a rotating manner by means of an electric motor in order to move the threaded spindle, together with the toothed rack, linearly in the axial direction in the housing.

The spindle drive may preferably be designed as a ball screw drive (BSD), in which balls can circulate in a rolling manner between the spindle nut designed as a ball nut and the thread of the threaded spindle. The gearwheel connected to the ball nut is mounted in a bearing arrangement, which has a bearing outer ring supported on the housing, for example the outer ring of a rolling bearing, whereof the inner ring is arranged on the gearwheel. To prevent tension in the ball screw drive, it is known in the prior art to resiliently tension the bearing outer ring against the housing via an axial spring element mounted externally at the end face, so that it is possible to compensate tilting movements caused by dynamic loads during operation. To enable such compensating movements for component- and temperature-related tolerances, it is furthermore known to mount a sleeve element between the bearing outer ring and the housing.

The combination of a spring element and a sleeve element has the advantage of good running smoothness and reduced wear. However, the complex manufacture and assembly may be disadvantageous.

In light of the problems explained above, an object of the present invention is to reduce the manufacturing and assembly effort.

### Presentation of the Invention

This object is achieved according to the invention by the steering column having the features of claim 1. Advantageous developments are revealed in the subclaims.

In a power assisted steering system for a motor vehicle, comprising a threaded spindle, which engages in a spindle nut, extends axially in the direction of a spindle axis and is axially displaceable in a housing, and a drive unit having a gearwheel, which is connected to the spindle nut in a rotationally fixed manner, can be driven for rotation about the spindle axis and is rotatably mounted in the housing in a bearing arrangement which has at least one bearing outer ring, which is axially supported on the housing at the end face via a spring element and which is received coaxially in a sleeve element and held radially in the housing, it is provided according to the invention that the spring element is formed as a spring portion and the sleeve element is formed as a sleeve portion, connected in one piece to the spring portion, on a one-piece carrier sleeve.

According to the invention, a one-piece, integrated carrier sleeve is provided, which has a spring portion, which may assume the function of the separate spring element in the prior art, and a sleeve portion, which has the function of the likewise separate sleeve element in the prior art.

Thanks to the invention, instead of the two components which are manufactured and assembled individually in the prior art, only a single carrier sleeve is required, whereby the production, handling and assembly effort is advantageously reduced.

Moreover, a further essential advantage consists in that, unlike in the prior art, the relative positioning and orientation of the spring and sleeve element is already clearly pre-defined in the inventive carrier sleeve due to the non-releasable one-piece connection and, in particular, tolerances and incorrect positioning relative to the bearing outer ring may also be reduced. This results in positive synergy effects during both the manufacture and operation of a power assisted steering system.

The spring portion is preferably formed and arranged on the carrier sleeve in such a way that, in the assembled state, it is arranged axially between an outer end face of the outer bearing ring, which end face faces away from the gearwheel, and an abutment surface on the housing, which abutment surface is axially opposite the said end face.

The sleeve portion preferably extends axially from the spring portion, and is configured and dimensioned such that the carrier sleeve may be pushed externally onto the bearing outer ring in the axial direction until the spring portion lies axially against the end face. In other words, the carrier sleeve is configured approximately in the form of a cup, wherein the sleeve portion represents the cup wall and the spring portion is arranged on the cup base. For assembly purposes, it is merely necessary to insert the bearing outer ring into this cup-like structure until its end face strikes the inside of the cup base axially. This already enables a clear relative positioning of the sleeve element, spring element and bearing arrangement, which cannot be achieved in the prior art or can only be achieved with additional adjustment.

It may preferably be provided that the spring portion protrudes radially inwards from the sleeve portion. The sleeve portion has an axial through opening in which the bearing outer ring may be received. The spring portion may be arranged on that end of the sleeve portion which faces away from the bearing outer ring and may project inwards into the through opening. In this case, the spring portion may have the basic shape of washer which is arranged coaxially to the spindle axis and is arranged axially between the bearing outer ring and the housing.

In an advantageous embodiment, it may be provided that the spring portion has a wave spring. The wave spring, as a compression spring, may be formed in a known manner as a wave washer, which has undulations, i.e. wave-like forms, which project axially forwards and backwards and are arranged in a successively alternating manner in the circumferential direction. Such a wave spring is easy to produce and enables a sufficiently high, defined axial spring force along with small dimensions.

A further option is that the spring portion has a disk spring. An axial compression spring designed as a disk spring is formed by a washer which substantially has the shape of a lateral cone surface and can be resiliently compressed in the axial direction, leading to a flattened shape. A disk spring may preferably be arranged such that it tapers conically as seen from the sleeve portion so that, in its outer radial edge region, where it is connected to the sleeve portion, it is lies axially against the bearing outer ring, and, in its radially inner region, it is axially supported against the housing by its outer side which faces away from the bearing outer ring.

The sleeve portion may preferably be designed in the form of a tube. To this end, the sleeve portion may have a preferably hollow cylindrical tube portion, which has an inner diameter matched to the outer diameter of the bearing outer ring, so that the bearing outer ring may be held therein with little play or preferably without play. The axial width may be adapted to the width of the bearing outer ring in order to completely or partially embrace it.

It is possible that the sleeve portion is resiliently tensioned radially externally against the bearing outer ring. This may be achieved in that the sleeve portion has at least one or more spring elements acting in the radial direction, or is itself configured as a radially expandable element or comprises such an element. During the insertion of the bearing outer ring, the sleeve portion or the spring element(s) is/are spread radially apart so that the bearing outer ring is resiliently clamped and held. One advantage is the simplified assembly, in that the carrier sleeve is fixed on the bearing outer ring as a result of pushing the sleeve portion on axially, wherein the spring portion has assumed its position and the bearing including the carrier sleeve may be inserted into the housing.

One advantageous development may be that the sleeve portion is segmented in the circumferential direction. The segmentation may be generated by axial incisions in the end which faces away from the spring portion. Segments extending in the axial direction are thus formed, which are fixed on the spring portion at one end and whereof the other, free end, may be resiliently deflected in the radial direction. In other words, these segments form resilient spring tongues in the radial direction, between which the bearing outer ring may be clamped. Such spring tongues may be manufactured with little effort and matched to the bearing outer ring and may enable simple assembly.

It may furthermore be provided that the sleeve portion has fastening means for axial fixing on the outer bearing ring. The fastening means may be arranged, for example, radially internally, for example internally on the above-described segments or spring elements which can be clamped in a fixed manner on the bearing outer ring. Means for improving the force fit may be provided, for example a surface structure or a roughening and, alternatively or additionally, a friction-increasing coating or the like. Additionally or alternatively, form-fitting elements holding the bearing outer ring may be provided, for example latching elements embracing the bearing outer ring. For example, the above-described spring tongues may comprise resilient latching arms having inwardly directed latching projections or the like.

It may be provided that the carrier sleeve is formed from a metallic material. For example, the carrier sleeve along with the spring and sleeve portion may be efficiently provided as a plastically formed one-piece sheet-metal part, for example of steel or spring steel sheet, by punching, pressing, bending and the like.

It is likewise possible that the carrier sleeve is formed from plastic. This enables efficient manufacture as a one-piece plastic molded part, preferably plastic injection molded from a thermoplastic material. The advantages in this case are the high degree of design freedom, the resilient properties which can be set within a wide range via the shape and material, and an advantageous sliding behavior in conjunction with the metallic bearing outer ring and the likewise metallic housing, whereby low-noise and low-wear operation is ensured. A high load-bearing capacity and good durability may be realized as a result of using a fiber-reinforced plastic, for example a fiber-filled thermoplastic material.

It may be provided that a rolling bearing of the bearing arrangement has the bearing outer ring. In this case, the bearing outer ring forms the outer ring of a radial or inclined rolling bearing, for example of a ball bearing, and accordingly has a rolling body raceway. Rollable rolling bodies are arranged between this rolling body raceway and an opposing inner rolling body raceway on an inner or internal bearing ring arranged on the gearwheel.

The gearwheel may be arranged axially between two bearings in the bearing arrangement. The bearing arrangement preferably has two bearings, between which the gearwheel is resiliently pretensioned in the axial direction by the resilient pre-tensioning force exerted by the spring elements. Axial compensating movements and tilting movements are thus enabled, whereby play caused by component tolerances and temperature fluctuations may be compensated.

If the two bearings are designed as inclined ball bearings, in which a connecting line between the rolling points of the balls is inclined with respect to the spindle axis, a mirror-symmetrical arrangement of the two bearings may produce an X configuration, in which the connecting lines intersect the spindle axis between the bearings, or an O configuration, in which the points of intersection are located outside the bearing arrangement. In terms of the manufacturing effort and operation, both designs may be optimized by the inventive carrier sleeve.

It may preferably be provided that the bearing arrangement comprises two inventive carrier sleeves, which are each arranged on a bearing outer ring. As a result of this, a mirror-symmetrical arrangement relative to a transverse plane is formed, in which the sleeve portions face one another axially whilst the spring portions face away from the gearwheel axially on both sides.

Alternatively to the preceding arrangement having two carrier sleeves, it is possible to use only one carrier sleeve, which is mounted on a bearing outer ring on only one side. The effort may thus be reduced if a small degree of compensation is required.

The threaded spindle is preferably connected to a toothed rack of a rack and pinion steering gear.

The threaded spindle and the spindle nut preferably form a ball screw drive.

### DESCRIPTION OF THE DRAWINGS

Advantageous embodiments of the invention are explained in more detail below with reference to the drawings. In detail:

FIG. 1 shows a schematic perspective view of an inventive steering system;

FIG. 2 shows a schematic perspective partial view of the spindle drive of the steering system according to FIG. 1 in isolation;

FIG. 3 shows a longitudinal section along the spindle axis through the spindle drive according to FIG. 2;

FIG. 4 shows a schematic illustration, exploded in the axial direction, of the bearing arrangement of the spindle drive according to FIGS. 2 and 3;

FIG. 5 shows a perspective view of an inventive carrier sleeve;

FIG. 6 shows a schematic exploded illustration of the bearing arrangement in a second embodiment;

FIG. 7 shows a longitudinal section through the bearing arrangement according to FIG. 6;

FIG. 8 shows an enlarged illustration of a detail from FIG. 7.

### EMBODIMENTS OF THE INVENTION

In the various figures, the same parts are always denoted by the same reference signs and are therefore generally also only mentioned or explained once.

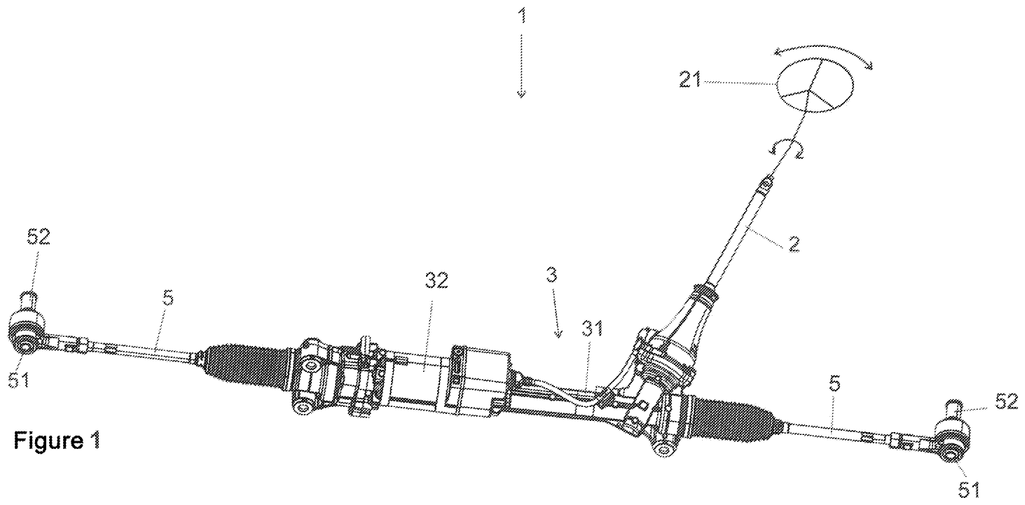

FIG. 1 shows a power assisted steering system 1 of a motor vehicle steering system in a schematic view. This power assisted steering system comprises a steering shaft 2, which is connected to a steering wheel 21, possibly via an intermediate shaft (not illustrated), at its rear end facing the driver's position in the vehicle interior, and may be rotated to input a manual steering command, as indicated by the arrow.

The front end of the steering shaft 2 is rotatably mounted in a housing 31 of a steering gear 3.

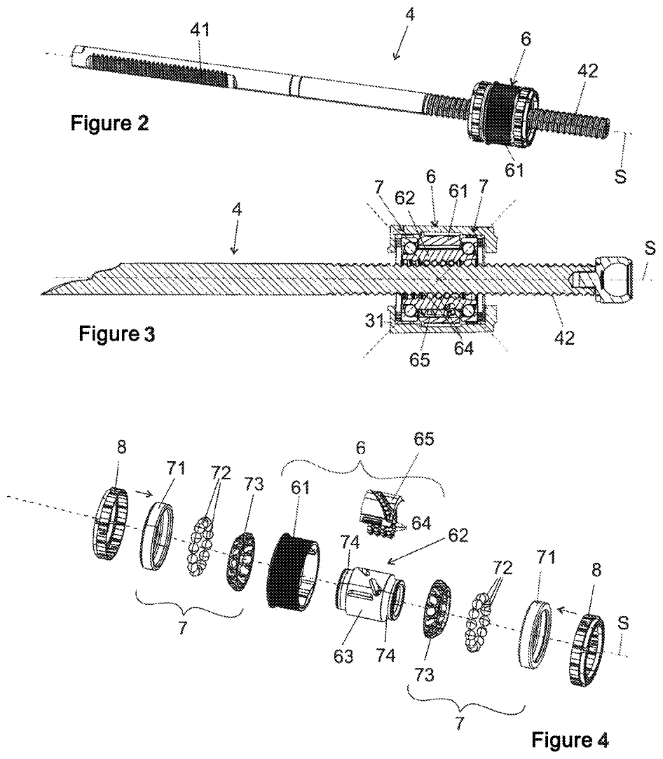

In the housing 31, a toothed rack 4 (illustrated separately in FIG. 2), which extends in the direction of a spindle axis S, is mounted to be displaceable in its longitudinal direction i.e. in the direction of said spindle axis S, as indicated by a double headed arrow in FIG. 1.

The toothed rack 4 has a toothing 41 and a thread 42. A steering pinion, mounted on the steering shaft 2 and arranged concealed within the housing 31, is in engagement with the toothing 41 so that a rotation of the steering shaft 2 is converted into a linear movement of the toothed rack 4 in the housing 31. At its two ends, to transfer the steering power, the toothed rack 4 is connected to the steering knuckles 52 of the steered wheels (not illustrated here) via track rods 5 and joint heads 51.

An auxiliary power drive has an electric motor 32 which is mounted on the housing 31 and via which a gearwheel 6 can be driven for rotation about the spindle axis S. For this purpose, the gearwheel 6 has an external ring gear 61 revolving coaxially about the spindle axis S and having a toothing which meshes with a drive pinion of the motor 32.

The hub of the gearwheel 6 has a spindle nut 62, which is screwed onto the thread 42 of the toothed rack 4 and is connected to the ring gear 61 in a fixed manner. In the example shown, the spindle nut 62 is designed as a ball nut or ball screw nut, having a threaded body 63 with helical ball channels. Balls circulate in a guided manner between the helical ball channels and the turns of the thread 42 and are returned externally via a deflection body 65, which is elevated radially outwards in the exploded illustration of FIG. 4.

The gearwheel 6 is mounted for rotation about the spindle axis S in a bearing arrangement between two mirror-symmetrically arranged rolling bearings 7 and, in this case, is axially supported against the housing 31 in the direction of the spindle axis S.

Each of the rolling bearings 7 has a bearing outer ring 71, in which balls 72 can roll internally, which balls are rotatably held in a ball cage 73. The bearing inner ring, which is connected to the gearwheel 6 in a fixed manner, is formed by ball raceways 74, which are arranged on the threaded body 63 of the spindle nut 62 and along which the balls 72 may roll. The ball raceways 74 may preferably be formed in one piece on the threaded body 63.

The thread 42 forms the threaded rod of a ball screw drive, which, by means of the motor 32, may be linearly axially displaced in the direction of the spindle axis via a rotating drive. Auxiliary power supporting the steering torque introduced manually via the steering shaft 2 may thus be exerted on the toothed rack 4.

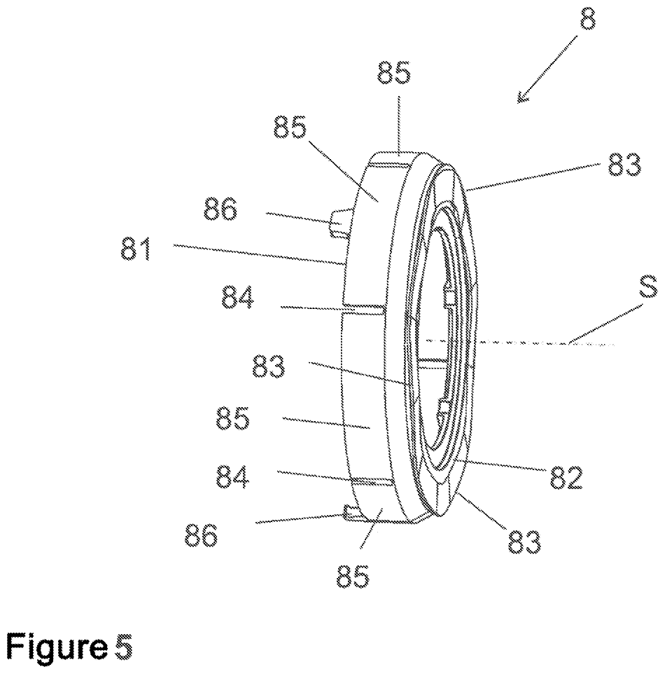

An inventive carrier sleeve 8 (illustrated separately in FIG. 5) is pushed externally onto the bearing outer ring 71 in the axial direction in each case, as indicated by the arrows in FIG. 4.

The connecting lines (depicted by dashed lines in FIG. 3) between the contact points between the balls 72 and the ball raceways 74 and the bearing outer ring 71 intersect the spindle axis between the two rolling bearings 7 so that an X configuration is produced.

The carrier sleeve 8 has a tubular sleeve portion 81, which has a substantially hollow cylindrical design. The sleeve portion 81 is connected in one piece to an end-face spring portion 82. In the embodiment of FIGS. 3, 4 and 5, this spring portion is designed as a wave spring in the form of a washer, which protrudes radially inwards into the passage of the sleeve portion 81 and has waves 83 which undulate forwards and backwards in the direction of the spindle axis S. The carrier sleeve this has an approximately cup-shaped design, wherein the wave spring forms the base.

In the installed state, the undulating spring portion 82 is axially pre-tensioned between the outer end face of the bearing outer ring 71 and a preferably ring-shaped abutment inside the housing 31.

Resilient spring tongues 85 are formed by a plurality of axial incisions 84, which are distributed over the circumference and are incorporated from the side which faces away from the spring portion 82. These spring tongues are radially spaced such that, during the push-on procedure, they are spread slightly apart in a resilient manner in the radially outward direction by the bearing outer ring 71 and thereby elastically clamp the bearing outer ring 71. The carrier sleeve 8 may be simply pushed on axially for assembly purposes, wherein the outer bearing ring 71 penetrates into the sleeve portion 81 until it lies internally against the spring element 72. In this case, it is resiliently clamped by the spring tongues 85 and held with force fit.

Fastening means 86 may be provided axially with respect to the spring tongues 85, at the end which faces away from the spring portion 82, which fastening means have, for example, inwardly protruding holding projections which may embrace the bearing outer ring 71 or between which the bearing outer ring 71 may be snapped in place with form fit.

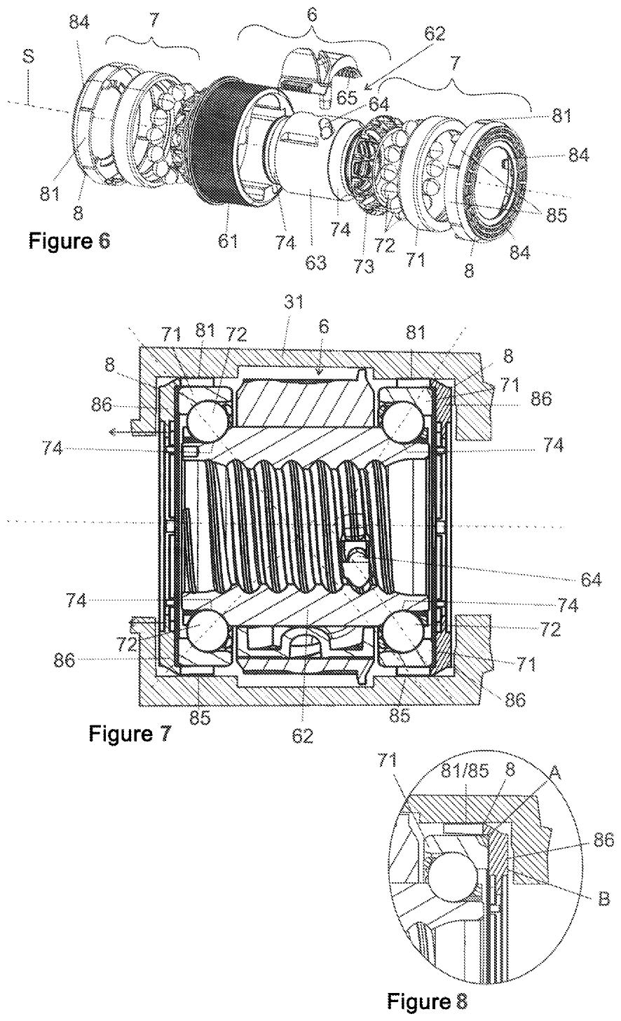

FIGS. 6, 7 and 8 show a bearing arrangement having bearings 7, with an inventive carrier sleeve 8 in a second embodiment. The other components are denoted by the same reference signs provided they have the same functional effect.

The carrier sleeve 9 likewise has a similarly designed sleeve portion 81 for fixing on the outer circumference of the bearing outer ring 71.

Instead of the wave spring having the undulating spring portion 82, a radially inwardly protruding ring portion 86, tapering axially outwards from the sleeve portion 81 in the form of a lateral cone surface, is provided. This ring portion is located with its radially outer contact region A against the end face of the bearing outer ring 71 and with its radially inner contact region B, which faces axially outwards, against the housing 31, as can be seen in the enlarged detailed view of FIG. 8. The ring portion 86 thus acts as a disk spring, which is in the form of a lateral cone surface and by means of which an axial resilient pre-tensioning force may be exerted on the bearing 7 and the gearwheel 6 arranged therebetween.

The carrier sleeve 8 may be designed as a one-piece plastic molded part, for example injection molded from a thermoplastic material, which may be fiber-reinforced. Alternatively, it is conceivable and possible for it to be manufactured as a formed sheet-metal part, for example cold formed from steel or spring steel sheet.

### LIST OF REFERENCE SIGNS

1 Power assisted steering system

2 Steering shaft

21 Steering wheel

3 Steering gear

31 Housing

32 Motor

4 Toothed rack

41 Toothing

42 Thread

5 Track rod

51 Joint head

52 Steering knuckle

6 Gearwheel

61 Ring gear

62 Spindle nut

63 Threaded body

64 Balls

65 Deflection body

7 Bearing (rolling bearing)

71 Bearing outer ring

72 Balls

73 Ball cage

74 Ball raceway

8 Carrier sleeve

81 Sleeve portion

82 Spring portion

83 Shaft

84 Incision

85 Spring tongue

86 Ring portion

S Spindle axis

A, B Contact regions

1.-14. (canceled)

15. A power assisted steering system for a motor vehicle, comprising:
a threaded spindle that engages in a spindle nut, extends in a direction of a spindle axis, and is axially displaceable in a housing; and
a drive unit having a gearwheel that is connected to the spindle nut in a rotationally fixed manner, is rotatably drivable about the spindle axis, and is rotatably mounted in the housing in a bearing arrangement, with the bearing arrangement including a bearing outer ring that is axially supported on the housing at an end face via a spring element and that is received coaxially in a sleeve element and held radially in the housing,
wherein the spring element is configured as a spring portion and the sleeve element is configured as a sleeve portion that is connected in one piece to the spring portion, on a one-piece carrier sleeve.

16. The power assisted steering system of claim 15 wherein the spring portion protrudes radially inwards from the sleeve portion.

17. The power assisted steering system of claim 15 wherein the spring portion has a wave spring.

18. The power assisted steering system of claim 15 wherein the spring portion has a disk spring.

19. The power assisted steering system of claim 15 wherein the sleeve portion is a tube.

20. The power assisted steering system of claim 15 wherein the sleeve portion is resiliently tensioned radially externally against the bearing outer ring.

21. The power assisted steering system of claim 15 wherein the sleeve portion is segmented in a circumferential direction.

22. The power assisted steering system of claim 15 wherein the sleeve portion includes fastening means for axial fixing on the bearing outer ring.

23. The power assisted steering system of claim 15 wherein the one-piece carrier sleeve is comprised of metallic material.

24. The power assisted steering system of claim 15 wherein the one-piece carrier sleeve is comprised of plastic.

25. The power assisted steering system of claim 15 wherein a rolling bearing of the bearing arrangement includes the bearing outer ring.

26. The power assisted steering system of claim 15 wherein the gearwheel is disposed axially between bearings in the bearing arrangement.

27. The power assisted steering system of claim 15 wherein the threaded spindle is connected to a toothed rack of a rack and pinion steering gear.

28. The power assisted steering system of claim 15 wherein the threaded spindle and the spindle nut form a ball screw drive.
